(19) United States
(12) Patent Application Publication
(10) Pub. No.: US 2008/0033825 A1
(43) Pub. Date: Feb. 7, 2008

(54) Method and apparatus for a reward system for merchants for credit card processing and merchant cash advances

(76) Inventor: David Goldin, New York, NY (US)

Correspondence Address: FOX ROTHSCHILD LLP, 100 PARK AVENUE, SUITE 1500, NEW YORK, NY, 10017, US

(21) Appl. No.: 11/880,406

(22) Filed: Jul. 20, 2007

Related U.S. Application Data
(60) Provisional application No. 60/832,100, filed on Jul. 20, 2006.

(51) Int. Cl. G06Q 30/00

(52) U.S. Cl. 705/14

(57) ABSTRACT

A method and apparatus for implementation of a reward system for merchants for credit card processing or merchant cash advances is presented. The reward system is implemented by application of a pre-determined algorithmic formula to purchase transaction volumes and/or merchant cash advance contracted amounts. The purchase transaction volumes are garnered in the normal course of business by merchants and/or vendors in the processing of customer purchase transactions via credit cards, or other ID transaction cards, for merchandise or services. Such purchase transaction volumes are tabulated for a specific time period and then sent to the credit card processor. The merchant cash advance contracted amounts can rely on accruals based on size of the cash advance, payoff amounts, time or dollar intervals, or full payoff. Upon application of the pre-determined algorithmic formula to the credit card purchase transaction volumes or merchant cash advance contracted amounts, a determination of a reward to be transferred, sent or paid out to the merchant is made. Such rewards may be in the form of cash back, specific merchandise or accumulation of points for later redemption.

### PRIOR PROVISIONAL PATENT APPLICATION

The present application claims the benefit of U.S. Provisional Application No. 60/832,100 filed Jul. 20, 2006, the disclosure of which is hereby incorporated by reference.

### FIELD OF THE INVENTION

The present invention relates to a method and apparatus for a reward system for merchants for processing of credit card transactions with select processors and/or for receipt of cash advances and/or funding from select processor and/or providers, and, more particularly, to a method and apparatus by which rewards can be tabulated and distributed to merchants based on credit card transaction volumes with specific processors and/or contracted cash advance amounts and/or funding paid to and then repaid by the merchants.

### BACKGROUND OF THE INVENTION

It is paramount in order for a financial services provider to be successful in the financial industry to be able to set apart the companies' services from that of their competitors. As the industry is so competitive, financial services providers look for every edge to gain and hold customers. Indeed, as an example, credit card companies frequently reward consumers to utilize their credit cards by rewarding them with reward programs, rebates and/or cash back based on how much they charge on their credit card. The amount a customer earns is typically measured monthly or annually. These programs are well-known and widely practiced by various credit card issuers. In some instances the programs and the systems to keep track of the various rewards have become so complicated that patent protection has been sought.

For instance, U.S. Pat. No. 7,072,851 issued Jul. 4, 2006 to Wilcox et al., and entitled “System and Method for Administrating a Credit Card Use Incentive Program by which a Credit Card Holder earns Rebate in the form of an additional Payment toward an outstanding loan principal to reduce overall cost of the Installment Loan”, relates to a credit card incentive program in which a credit card issuer issues a credit card to a credit card holder who has an outstanding installment loan account with a lending institution. Through use of the credit card the credit card holder can earn a periodic rebate. The rebate is in the form of a payment to the lending institution made by the credit card issuer on behalf of the credit card holder and is applied against the outstanding principal on the installment loan account. The system and method requires that the credit card holder have an installment loan account and that the credit card account remain in good standing for payments to be issued. The system and method, however, does not provide any incentive to the merchants/vendors for participating in the system.

Also for instance, U.S. Pat. No. 6,195,644 issued Feb. 27, 2001 to Bowie, and entitled “Computer Program and System for Credit Card Companies for Recording and Processing Bonus Credits Issued to Card Users”, relates to a system for recording and processing data relating to consumer credit or debit card transactions with particular service providers who then award bonus credits to such consumers. The system relies on a computer program which records data representing charges made by a customer to purchase products and services from vendors. The computer program, resident with the credit card company, maintains a record of the transactions and sends the credit card customers periodic statements of their awards program credits with the vendor. In this manner then each of the participating vendors do not need to keep track of the customer's program rewards points. However, once again, there is no incentive provided to the merchants/vendors for participating in any particular credit card's system.

And yet again for instance, U.S. Pat. No. 5,513,102 issued Apr. 30, 1996 to Auriemma, and entitled “Data Processing Methods of Implementing an Award to an Authorized User of a Credit Card”, relates to a method by which a credit card user earns, for each transaction amount or payment amount of at least a predetermined size, a coupon redeemable by the user for a lottery ticket. With the lottery ticket, the user has an opportunity to recover at least a portion of, and potentially in excess of, the user's transaction based expenditures or payments which qualified him for the coupon. Transaction amounts or payment amounts in excess of a predetermined size but insufficient to earn an additional coupon, are stored and then applied to the credit card user's transaction or payment amounts record for use during the next subsequent billing period. While potentially a wind-fall for the customer, again here there is no incentive for the merchant/vendor to participate.

In spite of the awards and/or rebate programs mentioned above, as can be seen there are no programs in the financial services industry or the marketplace in general that reward the merchant (or retailer) any compensation or awards based on how much they process in terms of credit card purchases or how much they receive in terms of cash advances or funding against their credit card receivables. Thus, in the eyes of the merchant/vendor, there are no rewards program means by which credit card processors (also commonly referred to as an Acquirer or Independent Sales Organization (ISO)) or financing providers (also commonly referred to as a Working Capital Provider or Merchant Cash Advance Provider) can differentiate themselves from their competitors in the financial services industry.

As credit card processors are seeking ways to differentiate themselves from the competition rather than just on the lowest possible processing fees, there is clearly a need in the industry for such credit card processors to offer a rewards program to merchants as either a reason to get merchants to sign up for processing of their cards or not to leave their service for another. Likewise, the credit card processors and/or merchant cash advance providers must differentiate themselves from the competition in order to give merchants a reason to get and/or receive cash advances or funding from them and not from some other processor and/or provider.

### SUMMARY OF THE INVENTION

Accordingly, the present invention is directed to providing a means by which credit card processors and/or merchant cash advance providers can direct rewards to various merchants (or retailers) as a means for incentives. Such direction of such rewards can be based upon the total credit card purchase transaction volumes over a given period of time. Alternatively, or in conjunction therewith, direction of such rewards can be based upon cash advances or funding taken out by the merchant under contract, agreement or otherwise. The rewards can consist of cash back, merchandise (gifts), or accumulation of points for later redemption.

Determination of the extent of the rewards earned by the merchant is by application of an algorithm. The algorithm can take into account the credit card purchase transaction volume submitted by the merchant. Alternatively, the algorithm can take into account the cash advance or funding amount the merchant has received in exchange for credit card receipts and/or receivables or based upon the paid-off amount of the cash advance or funding amount.

Upon processing and determination, the merchant may select the qualifying awards. Payment or delivery of the awards can be done either directly by the credit card processor and/or merchant cash advance provider or a 3^{rd} party.

The present invention, including its features and advantages, will become more apparent from the following detailed description with reference to the accompanying drawings.

### BRIEF DESCRIPTION OF THE DRAWINGS

FIG. 1 is an illustration of the steps of a methodology for providing rewards to merchants and/or vendors, according to an embodiment of the present invention.

FIG. 2 is an illustration of an apparatus for providing rewards to merchants and/or vendors, according to an embodiment of the present invention.

FIG. 3 is an illustration of the steps of a methodology for providing rewards to merchants and/or vendors, according to an alternate embodiment of the present invention.

FIG. 4 is an illustration of an apparatus for providing rewards to merchants and/or vendors, according to an alternate embodiment of the present invention.

### DETAILED DESCRIPTION

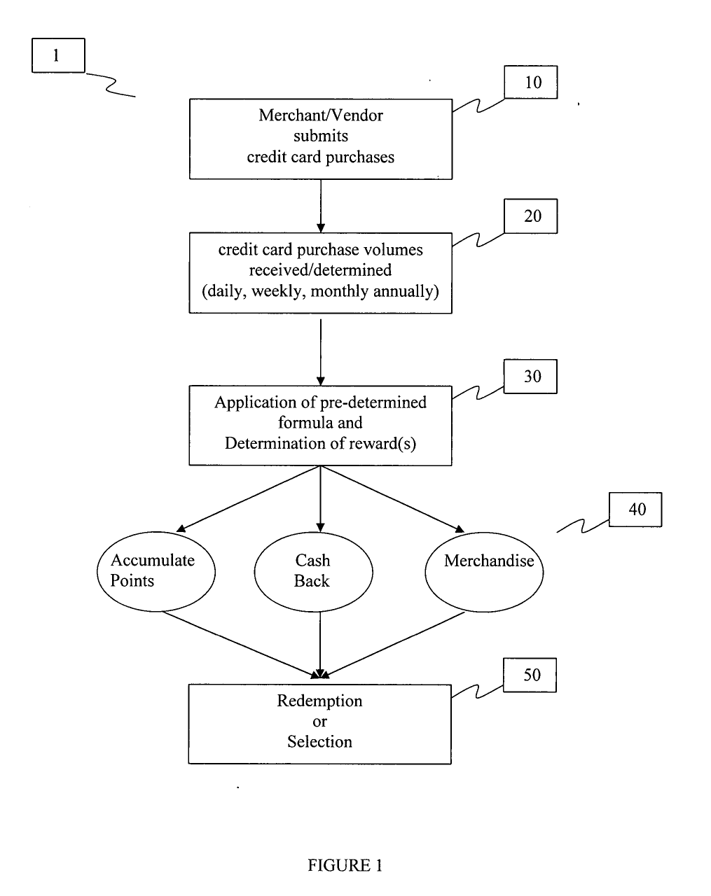

FIGS. 1 through 4 illustrate a method and apparatus for a credit card processing and cash advance merchant reward system 1 in which a merchant and/or vendor 100 is enrolled in a rewards program that rewards the merchant according to a credit card purchase transaction volume or a merchant cash advance contracted amount.

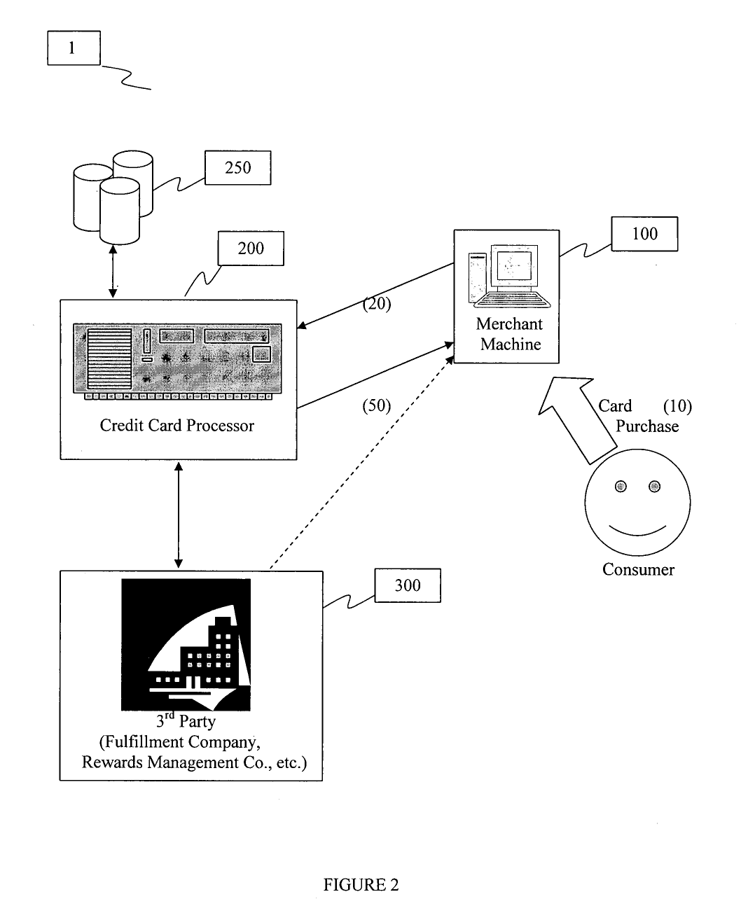

Referring now specifically to the method and apparatus shown in FIGS. 1 and 2, a Consumer makes a purchase utilizing a credit card or some other form of ID card based transaction that requires processing. Thus in step 10 a merchant/vendor submits the purchase being made by the Consumer in the normal course of business. For example, the merchant 100 will take the credit card proffered by the Consumer and swipe the card on the merchant's credit card machine. Such purchases of the merchant's customers may also be accomplished via telephone or the internet. It is to be understood, then, that such processing of the transaction is accomplished via well known and understood methodologies and systems. It is to be further understood, of course, that well known and understood security measures and precautions can be implemented for such transactions.

The credit card transaction having been completed, in step 20, volume credit card transactions as made with the merchant 100 are received and processed by the credit card processor 200. The transaction volumes can be based on any set time period, such as daily, weekly, monthly or even annually. The transaction volumes can be transmitted via any secure communication means. Data from such transactions can then be stored, if needed, in appropriate computer data bases 250.

While such implementation is disclosed on the basis of a transaction volume being based on credit card purchases, it is to be understood that it is possible for the merchant credit card reward system 1 to be implemented by the credit card processor's 200 and the merchant 100 based on any conceivable way with which merchant 100 may accept and process transactions. In other words, in any fashion in which purchase transactions may be accomplished via a credit transaction the reward system may be implemented.

The purchase transaction volumes having been sent and received, in step 30, a predetermined mathematical algorithmic formula is applied based on the purchase transaction volumes received by the processor 200. Based on the application of the formula, a determination of the reward to be issued to the merchant 100 is then made. As shown in step 40, the determined reward to be offered to the merchant 100 can be an accumulation of points, cash back, or merchandise. It is to be understood, of course, that more than one category of rewards may be offered or made available to the merchant.

For example, an algorithmic formula may be implemented with a determination resulting in the accumulation of points reward category. Merchant 100 receives X amount of points for Y amount of dollars processed. X and Y can be a one to one relationship. For instance, merchant 100 will earn 1 point for every $1 processed. Alternatively such relationship may be scaled. For example, a merchant may earn 1 point for every 12 credit card transaction dollars processed. It is to be understood, of course, that the algorithmic formula may be set at whatever relationship desired to allow for determination of the reward to be offered and/or whether the merchant qualifies for such reward.

Alternatively, merchant 100 may earn rewards in the alternative reward categories such as cash back or merchandise. For instance, if merchant 100 processes $50,000 per month or $600,000 per year, the merchant may receive merchandise such as a plane ticket voucher worth $500. Also for instance, based on such purchase transaction volume the merchant 100 may earn a reward resulting directly in $500 cash back.

In step 50 then, the merchant 100 may redeem or select from the variously offered rewards. Based on the redemption or selection of the reward by the merchant 100, the credit card processor 200 or third party 300 delivers, transfers, arranges for or pays out such reward to the merchant 100.

Based on application of the foregoing methodology and system, the following example is provided. In accordance with one of the possible categories of rewards, if a merchant processes $25,000 per month in visa and/or master card credit card sales the merchant would accumulate points based on that volume of transacted sales. Utilizing a 1 to 1 algorithmic formula relationship the merchant would thus earn 25,000 points. The points can then be redeemed for various rewards, such as travel rewards, gift cards, downloadable rewards (e.g., music/ring tones, etc.). Alternatively, the accumulation of points may be redeemed for the other rewards categories of cash back and/or merchandise.

In addition, it is to be understood that the above disclosure may be implemented such that the merchant can earn rewards for processing any type of card that has a customer identifier number at or through their place of business. In other words, the system need not be limited to that of use of a credit card. For instance debit cards, check cards, charge cards, T&E cards, purchase cards, smart cards and any pin-based cards may all be utilized.

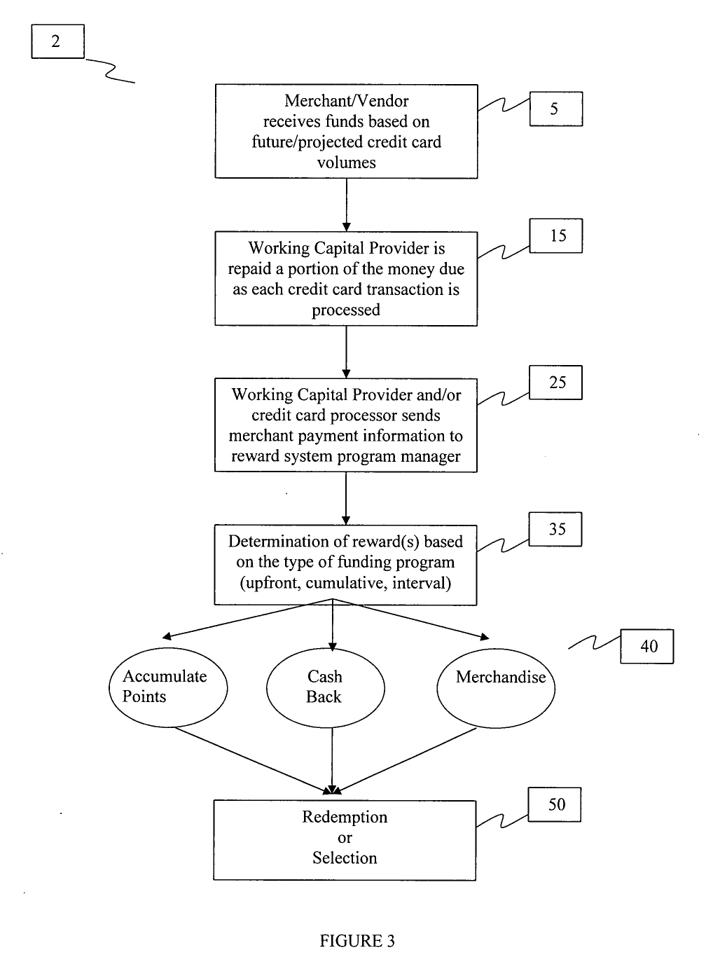

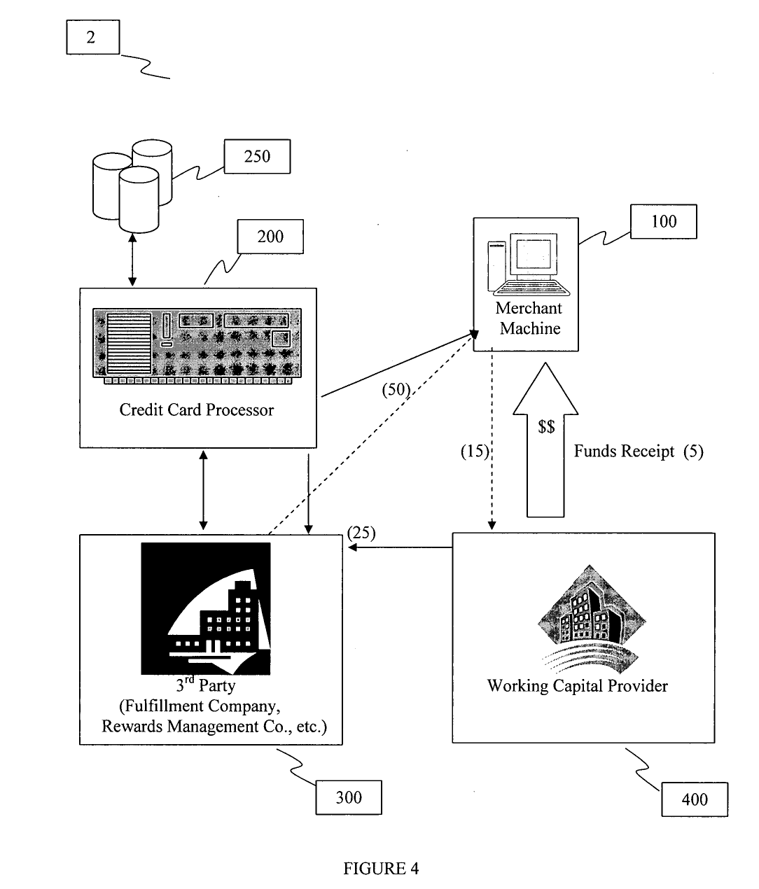

Referring now specifically to the method and apparatus shown in FIGS. 3 and 4, the rewards program may also be implemented through factoring of expected credit card receipts/receivables against a merchant cash advance distribution. That is, through a “working capital program”, merchant cash advances or funding to merchants, vendors or other small business owners 100 may be made based on expected future credit card purchase transaction volumes. In this rewards program, cash advances are made to small business owners and such advances can be tied to the future credit card transaction receipts the small business owners expect to receive. Alternatively, or in conjunction therewith, such advances can be tied to the payoff amounts.

Thus in step 5, a merchant 100 receives funding from a credit card processor 200 and/or a working capital provider 400 based on the merchant's future/projected credit card processing volumes. It is to be understood, of course, that the processor 200 and provider 400 may be one and the same company, affiliates, or separate parties, and that such funding may be accomplished via well known financial means. It is also to be understood, of course, that such funding can be securitized and/or collateralized by well known financial means. Credit card transactions for purchases made by consumers are then submitted and processed, as described above, during the merchant's normal course of business via credit card processor 200.

For example, merchant 100 might receive a $5,000 cash advance from credit card processor 200. In return, merchant 100 would agree that either a percentage of future credit card sales would be paid back to the merchant cash advance provider until $5,500 is collected, or a specific amount, such as the next $5,500 worth of credit card purchase transaction volume, would be processed through credit card processor 200. Such a program would be particularly well received in the sub-prime business owner market.

In step 15, as each credit card transaction is submitted and processed, the working capital provider 400 is repaid a portion of the cash advance and/or funding due in repayment. The process of repayment upon each credit card transaction continues until the working capital provider 400 is repaid the total repayment amount owed by the merchant 100. It is to be understood, of course, that such repayment may be accomplished by a variety of retrieval methods. For instance, such repayment may consist of the total amount of the credit card transaction receivable or a portion/percentage thereof, or rather such repayment may come from a direct deduction from the Merchant's bank or other financial accounts. In addition, such retrieval methods may be pegged to certain time intervals, other repayment criterias or the like.

In step 25, the working capital provider 400 and/or credit card processor 200 sends the merchant 100 repayment information to the reward system program manager 300. Such information can consist of total payments made, total outstanding debt remaining, or any information pertaining to repayment of the cash advance and/or funding.

In step 35, the rewards due the merchant are determined based on the type of funding program. That is, the method by which rewards are accrued can work in a variety of ways, such as: upfront award; award as payments are collected; award at end of funding program; award part up front, part at a later date; etc.

(1) Upfront Award accrual—wherein the merchant is awarded upfront points, cash rebate, prizes based on the size of the cash advance contracted for.

(2) Cumulative Award accrual—wherein points, cash rebate, and/or prizes are accumulated as the merchant pays off the advance. Such can be a set point for each dollar collected, or could be awarded in a specific time period (i.e., daily, bi-weekly, monthly, annually, or at any interval).

(3) Award accrual at Time and/or Dollar Intervals—wherein points, cash rebate, and/or prizes can be awarded at time intervals or a dollar level interval after the advance is given, not necessarily based on dollar amounts collected (e.g., part up front, part after X months—or after 9 months).

(4) Award accrual at the end of the advance—wherein all the points, cash rebate, and/or prizes can be awarded once the advance is paid off by the merchant.

As discussed above, in step 40 the determined reward to be offered to the merchant 100 can be an accumulation of points, cash back, or merchandise, and in step 50 the merchant 100 may redeem or select from the variously offered rewards. If the merchant defaults on the cash advance program or leaves the program for whatever reason (e.g., pays off early to refinance with another company), they would forfeit any points, cash rebate, prizes earned to date, but not yet redeemed. In this manner then, the rewards program can used as a way to also lower merchant attrition/default rates.

It is to be understood, of course, that the differing embodiments of the merchant reward system may be utilized together as a third embodiment. That is, a Merchant 100 may be enrolled in the rewards system and receive rewards for credit card transaction volumes, to which the algorithm will be applied to determine rewards eligibility, and for cash advances and/or funding tied to future credit card transactions, of which the funding program type will determine rewards eligibility.

As can be seen from the above disclosure, the rewards systems 1 and 2 can be utilized as an incentive, either separately or in conjunction, for a business owner to use a particular credit card processor and/or merchant cash advance provider over others. The system allows such processor and/or provider to differentiate their credit card transaction service and/or funding programs from competitors. This is especially true in light of the fact that merchants typically view credit card processing as an expense, that is, a cost of doing business. Fortunately, the reward systems of the present invention provide the merchant an offset of the expense of utilizing the credit card transaction system and/or merchant cash advance by providing them with rewards.

In the foregoing description, the method and apparatus of the present invention have been described with reference to specific examples. It is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative rather than in a restrictive sense.

What is claimed is:

1. A method for providing an incentive reward to a merchant for the utilization of a card processing service, the method comprising the steps of:
processing of at least one card transaction through the card processing service;
determining whether the merchant qualifies for the incentive reward based on a volume of processing of the at least one card transaction through the card processing service; and
providing the merchant with the incentive reward.

2. The method according to claim 1, further comprising the step of:
determining the volume of processing of the at least one card transaction through the card processing service.

3. The method according to claim 2, further comprising the step of:
determining the incentive reward to be provided to the merchant through application of a formula utilizing the determined volume of processing.

4. The method according to claim 1, further comprising the step of:
providing funding to the merchant through a funding program,
wherein the funding program is based on or includes at least one of:
the volume of processing of the at least one card transaction through the card processing service, and
a repayment of the funding via processing of the at least one card transaction through the card processing service.

5. The method according to claim 4, further comprising the step of:
determining the incentive reward to be provided to the merchant based on the funding program.

6. The method according to claim 4, further comprising the step of:
providing information regarding the repayment of the funding.

7. The method according to claim 4, wherein repayment of the finding comprises at least one of the steps of:
a payment consisting of the total amount of the at least one card transaction;
a payment consisting of a percentage amount of the at least one card transaction; and
a payment coming directly from the merchant's financial account.

8. The method according to claim 1, wherein the volume of processing of the at least one card transaction through the card processing service is tabulated based on at least one of a time period and a number threshold.

9. The method according to claim 1, wherein the step of providing the merchant with the incentive reward comprises:
an award program comprising of at least one of:
an award based on an accumulation of points,
a cash back award, and
an award of merchandise.

10. The method according to claim 1, wherein the step of providing the merchant with the incentive reward comprises at least one of the further steps of:
allowing the merchant to redeem an accumulation of points;
providing the merchant with cash back; and
allowing the merchant to select merchandise.

11. A method for a merchant reward system, the method comprising the steps of:
providing an incentive to a merchant to utilize a card transaction processing service, the incentive comprising at least one of:
a cash advance,
financing, and
an award; and
determining whether the merchant qualifies for the incentive based on a volume of processing of at least one card transaction through the card transaction processing service.

12. The method according to claim 11, further comprising the step of:
determining the volume of processing of the at least one card transaction through the card transaction processing service.

13. The method according to claim 12, further comprising the step of:
determining the incentive award to be provided to the merchant through application of a formula utilizing the determined volume of processing.

14. The method according to claim 13, wherein the incentive award comprises at least one of:
cash back; and
merchandise.

15. The method according to claim 11, further comprising the step of:
providing to the merchant through a funding program at least one of the cash advance incentive and the financing incentive,
wherein the funding program is based on or includes at least one of:
the volume of processing of the at least one card transaction through the card transaction processing service, and
a repayment of the at least one of the cash advance incentive and the financing incentive via processing of the at least one card transaction through the card transaction processing service.

16. The method according to claim 15, further comprising the step of:
determining the incentive to be provided to the merchant based on the funding program.

17. The method according to claim 15, further comprising the step of:
providing information regarding the repayment of the incentive.

18. The method according to claim 15, wherein repayment of the incentive comprises at least one of the steps of:
a payment consisting of the total amount of the at least one card transaction;
a payment consisting of a percentage amount of the at least one card transaction; and
a payment coming directly from the merchant's financial account.

19. The method according to claim 11, wherein the volume of processing of the at least one card transaction through the card transaction processing service is tabulated based on at least one of a time period and a currency threshold.

20. The method according to claim 11, wherein the step of providing the merchant with the award incentive comprises:
an award program comprising of at least one of:
an award based on an accumulation of points,
a cash back award, and
an award of merchandise.

21. The method according to claim 11, wherein the step of providing the merchant with the award incentive reward comprises at least one of the further steps of:
allowing the merchant to redeem an accumulation of points;
providing the merchant with cash back; and
allowing the merchant to select merchandise.
